(19) United States
(12) Patent Application Publication
(10) Pub. No.: US 2025/0206038 A1
(43) Pub. Date: Jun. 26, 2025

(54) RECORDING DEVICE

(71) Applicant: SEIKO EPSON CORPORATION, TOKYO (JP)

(72) Inventors: Dai TAMURA, MATSUMOTO-SHI (JP); Yuki KOMATSU, SHIOJIRI-SHI (JP)

(21) Appl. No.: 19/001,637

(22) Filed: Dec. 26, 2024

(30) Foreign Application Priority Data
Dec. 26, 2023 (JP) 2023-218997
Dec. 26, 2023 (JP) 2023-219003

(51) Int. Cl. B41J 3/60; B41J 11/04; B41J 13/03; B41J 13/036; B41J 13/08

(52) U.S. Cl. CPC B41J 3/60; B41J 11/04; B41J 13/03; B41J 13/036; B41J 13/08

(57) ABSTRACT

A first curved path 29 of a recording device includes a first guide surface 56 that guides a recording medium passed from a first feed path 27 and a first transport surface 57 that extends in a transport direction Dc from a downstream end of the first guide surface 56. The first guide surface 56 forms an acute angle with respect to a first extension line Le1 of the first transport surface 57. A second curved path 32 of the recording device includes a second guide surface 58 that guides the recording medium passed from a inversion path 31 and a second transport surface 59 that extends in the transport direction Dc from a downstream end of the second guide surface 58. The second guide surface 58 forms an acute angle with respect to a second extension line Le2 of the second transport surface 59.

The present application is based on, and claims priority from JP Application Serial Number 2023-219003, filed Dec. 26, 2023, and from JP Application Serial Number 2023-218997, filed Dec. 26, 2023, the disclosures of which are hereby incorporated by reference herein in their entirety.

### BACKGROUND

### 1. Technical Field

The present disclosure relates to a recording device such as a printer.

### 2. Related Art

For example, there is a recording device, such as JP-A-2019-099293, which ejects liquid from a recording head, which is an example of an image recording section. The recording head performs recording on a medium, which is an example of a recording medium. The recording device includes a medium tray that is an example of a first accommodation section that accommodates a medium. The recording device includes a first transport path that is an example of a first feed path, a first curved path, a switchback path that is an example of an inversion path, a second curved path, and a flap. The medium fed from the medium tray is fed to the recording head through the first transport path and the first curved path.

When recording on both sides of a medium, the medium recorded on one side is fed to the switchback path. The medium fed to the switchback path is fed to the second curved path across the first transport path. The flap closes the first transport path and guides a paper sheet to the second curved path.

In the recording device described in JP-A-2019-099293, a flap is necessary for transporting a medium. Therefore, the cost of the recording device increases.

In the recording device described in JP-A-2019-099293, a second curved path is provided separately from the first curved path for feeding the medium from the medium tray to the recording head. The recording device becomes larger as the number of paths increases.

### SUMMARY

A recording device includes an image recording section that records an image on a recording medium; a first accommodation section configured to accommodate the recording medium; and a transport path on which the recording medium is transported, wherein the transport path includes a first feed path, a first curved path, an inversion path, and a second curved path that intersect at an intersection, the first feed path is a path for feeding the recording medium fed from the first accommodation section to the first curved path, the first curved path is a path for feeding the recording medium to the image recording section, the inversion path is a path for feeding the recording medium on which recording was performed to the second curved path, the second curved path is a path for feeding the recording medium on which recording has been performed to the image recording section, the first curved path includes a first guide surface that guides the recording medium that was passed from the first feed path, and a first transport surface that extends in a transport direction from a downstream end of the first guide surface, the first guide surface forms an acute angle with respect to a first extension line of the first transport surface, the second curved path includes a second guide surface that guides the recording medium passed from the inversion path, and a second transport surface that extends in the transport direction from a downstream end of the second guide surface, and the second guide surface forms an acute angle with respect to a second extension line of the second transport surface.

A recording device includes an image recording section that records an image on a recording medium; an accommodation section configured to accommodate the recording medium; a transport path on which the recording medium is transported; and a transport section that transports the recording medium, wherein the transport path includes a feed path, a first curved path, an inversion path, and a second curved path that intersect at an intersection, the feed path is a path for feeding the recording medium fed from the accommodation section to the first curved path, the first curved path is a path for feeding the recording medium to the image recording section, the inversion path is a path for feeding the recording medium on which recording was performed to the second curved path, the second curved path is a path for feeding the recording medium on which recording has been performed to the image recording section, the transport section includes a first drive roller, a second drive roller, and a driven unit, the first drive roller is provided behind the image recording section in a depth direction and constitutes the first curved path, the driven unit includes a driven roller that sandwiches the recording medium with the first drive roller, and the second drive roller is provided behind the first drive roller in the depth direction to constitute the second curved path, and overlaps the driven unit in the depth direction.

A recording device includes an image recording section that records an image on a recording medium; an accommodation section configured to accommodate the recording medium; a transport path on which the recording medium is transported; and a transport section that transports the recording medium, wherein the transport path includes a feed path, a first curved path, an inversion path, and a second curved path that intersect at an intersection, the feed path is a path for feeding the recording medium fed from the accommodation section to the first curved path, the first curved path is a path for feeding the recording medium to the image recording section, the inversion path is a path for feeding the recording medium on which recording was performed to the second curved path, the second curved path is a path for feeding the recording medium on which recording has been performed to the image recording section, the transport section includes a first drive roller, a second drive roller, and a driven unit, the first drive roller is provided behind the image recording section in a depth direction and constitutes the first curved path, the driven unit includes a driven roller that sandwiches the recording medium with the first drive roller, and the second drive roller is provided behind the first drive roller in the depth direction to constitute the second curved path, and overlaps the driven unit as viewed in an axial direction.

### BRIEF DESCRIPTION OF THE DRAWINGS

FIG. 1 is a cross-sectional view of a first embodiment of a recording device.

FIG. 2 is a partially enlarged view of the recording device.

FIG. 3 is a partially enlarged view of the recording device.

FIG. 4 is a cross-sectional view of a second embodiment of the recording device.

FIG. 5 is a schematic plan view of a first drive roller and a second drive roller.

FIG. 6 is a partially enlarged view of the recording device.

### DESCRIPTION OF EMBODIMENTS

### First Embodiment

Hereinafter, an embodiment of a recording device will be described with reference to the drawings. The recording device is, for example, an inkjet type printer that prints by ejecting ink, which is an example of liquid, onto a recording medium such as a paper sheet.

In the drawing, assuming that a recording device 11 is placed on a horizontal plane, a direction of gravity is indicated by a Z-axis, and directions along the horizontal plane are indicated by an X-axis and a Y-axis. The X-axis, the Y-axis, and the Z-axis are orthogonal to each other. In the following description, a direction parallel to the X-axis is also referred to as a width direction X, a direction parallel to the Y-axis is also referred to as a depth direction Y, and a direction parallel to the Z-axis is also referred to as a vertical direction Z. Recording device

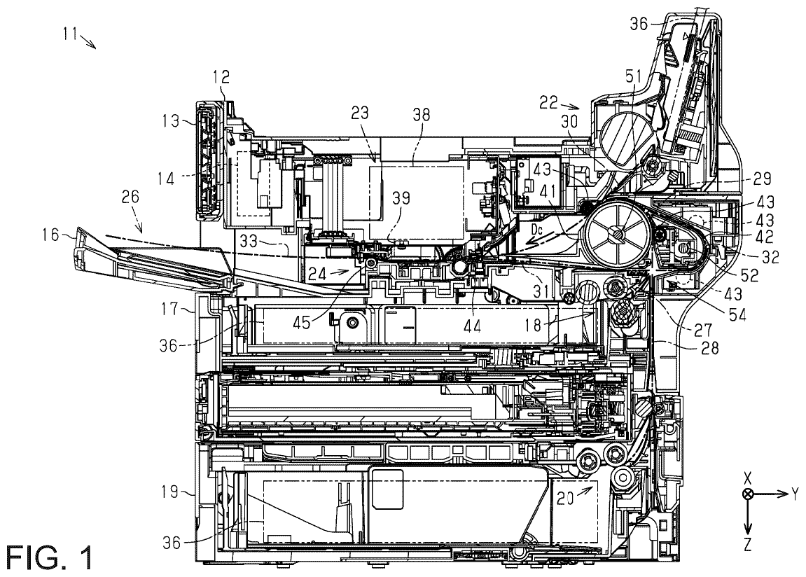

As shown in FIG. 1, the recording device 11 may include a housing 12, an operation section 13, and a control section 14. The recording device 11 may include a discharge tray 16, a first accommodation section 17, a first feeding section 18, a second accommodation section 19, and a second feeding section 20. The recording device 11 may include a manual feed section 22, an image recording section 23, and a transport section 24.

The recording device 11 includes a transport path 26. In the drawing, the transport path 26 is indicated by a single dot chain line. The transport path 26 may include a first feed path 27, a second feed path 28, a first curved path 29, a manual feed path 30, an inversion path 31, a second curved path 32, and a discharge path 33.

The housing 12 accommodates various configurations of the recording device 11.

The operation section 13 is for operating the recording device 11. The operation section 13 of the present embodiment is provided on a front surface of the recording device 11. The operation section 13 is configured to include, for example, a touch-screen, a display, and a button.

The control section 14 integrally controls the driving of each mechanism in the recording device 11. The control section 14 controls various operations executed in the recording device 11.

The control section 14 may be configured as a circuit including x: one or more processors that execute various processes in accordance with a computer program, B: one or more dedicated hardware circuits that execute at least a portion of various processes, or γ: a combination thereof. The hardware circuit is, for example, an application specific integrated circuit. The processor includes a CPU and memory, such as RAM and ROM, and the memory stores program code or commands configured to cause the CPU to perform processes. Memory, that is computer-readable medium, includes any readable medium that can be accessed by a general-purpose or dedicated computer.

The discharge tray 16 receives a recording medium 36 on which recording was performed. The discharge tray 16 may be provided on a front surface of the recording device 11.

The first accommodation section 17 and the second accommodation section 19 can accommodate the recording medium 36. The first accommodation section 17 and the second accommodation section 19 are formed, for example, in a box shape with an open top. The first accommodation section 17 and the second accommodation section 19 can accommodate a plurality of sheets of the recording medium 36 in a stacked state. The first accommodation section 17 and the second accommodation section 19 are individually detachable. The first accommodation section 17 and the second accommodation section 19 are detachable in a state of accommodating the recording medium 36. The first accommodation section 17 and the second accommodation section 19 may be attached by being pushed in the depth direction Y from a front surface of the recording device 11.

The first feeding section 18 feeds a plurality of sheets of the recording medium 36 accommodated in the first accommodation section 17 to the first feed path 27 one by one.

The second feeding section 20 feeds a plurality of sheets of the recording medium 36 accommodated in the second accommodation section 19 to the second feed path 28 one by one.

A plurality of sheets of the recording medium 36 can be set on the manual feed section 22. The recording medium 36 is set on the manual feed section 22 in a state in which a part of the recording medium 36 is exposed to the outside. The manual feed section 22 feeds a plurality of sheets of set recording medium 36 to the manual feed path 30 one by one.

The image recording section 23 records an image on the recording medium 36. The image recording section 23 may include a carriage 38 and a head 39. The carriage 38 of the present embodiment is configured to reciprocate in the width direction X. The head 39 is mounted on the carriage 38. The head 39 ejects liquid from a plurality of nozzles (not shown). The head 39 performs recording on the recording medium 36 by ejecting liquid toward the recording medium 36 while moving. The recording device 11 of the present embodiment is configured as a serial type printer in which the head 39 moves. The recording device 11 may be configured as a line type printer in which the head 39 is provided to be long in the width direction X.

### Transport Section

The transport section 24 transports the recording medium 36 along the transport path 26. A direction in which the transport section 24 transports the recording medium 36 is referred to as a transport direction Dc. The transport direction Dc is a direction along the transport path 26. The transport section 24 may include a first drive roller 41, a second drive roller 42, a plurality of driven units 43, a transport roller 44, and a discharge roller 45.

The first drive roller 41 is provided behind the image recording section 23 in the depth direction Y. The first drive roller 41 constitutes a part of the first curved path 29. The first drive roller 41 is rotatable about a first shaft 51. The first drive roller 41 rotates to transport the recording medium 36 along the first curved path 29. The first drive roller 41 rotates to transport the recording medium 36 along the inversion path 31.

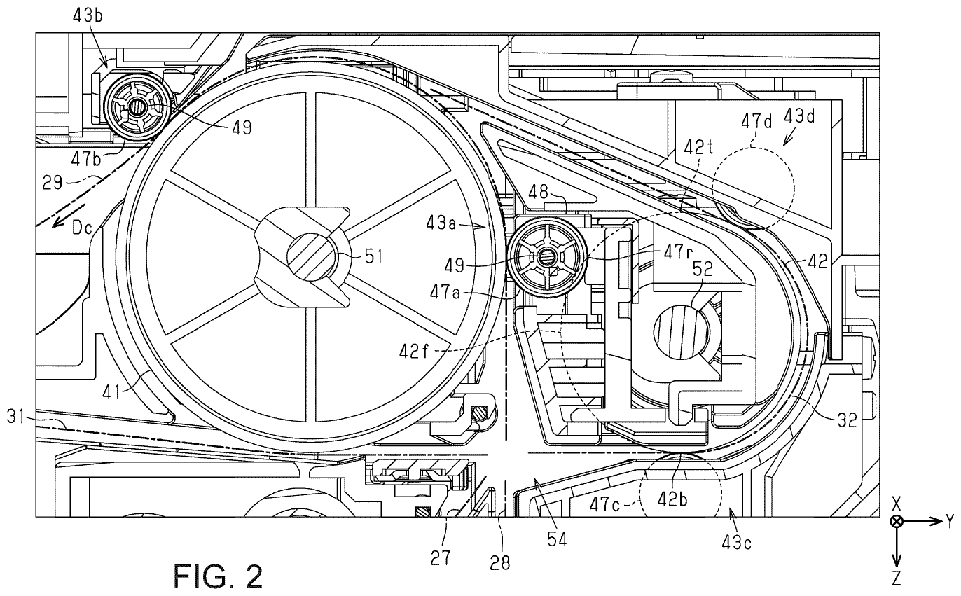

As shown in FIG. 2, the second drive roller 42 is provided behind the first drive roller 41 in the depth direction Y. The second drive roller 42 constitutes a part of the second curved path 32. The second drive roller 42 is rotatable about a second shaft 52. The second drive roller 42 rotates to transport the recording medium 36 along the second curved path 32.

The diameter of the second drive roller 42 may be smaller than the diameter of the first drive roller 41. That is, the curvature of the second curved path 32 is larger than the curvature of the first curved path 29. The second shaft 52 may be positioned below the first shaft 51. In the vertical direction Z, a lower end 42b of the second drive roller 42 may be positioned at substantially the same position as a lower end of the first drive roller 41.

The plurality of driven units 43 have the same configuration. When distinguishing a plurality of driven units 43, also referred to as a first driven unit 43a, a second driven unit 43b, a third driven unit 43c, and a fourth driven unit 43d. The driven unit 43 includes a driven roller. In the present embodiment, the driven rollers respectively included in the first driven unit 43a to the fourth driven unit 43d are also referred to as a first driven roller 47a to a fourth driven roller 47d.

The first driven unit 43a and the second driven unit 43b sandwich the recording medium 36 with the first drive roller 41. The third driven unit 43c and the fourth driven unit 43d sandwich the recording medium 36 with the second drive roller 42.

In the following, the first driven unit 43a will be described, and a common configuration will be denoted by the same reference symbols, so that a duplicate description thereof will be omitted.

As shown in FIG. 2, the first driven unit 43a may include a case 48, a driven shaft 49, a spring (not shown), and a first driven roller 47a.

The case 48 accommodates various configurations of the first driven unit 43a. The case 48 holds the driven shaft 49.

The driven shaft 49 extends in the width direction X. An axial direction of the driven shaft 49 is parallel to the first shaft 51 and the second shaft 52. The axial direction of the driven shaft 49 is parallel to the width direction X.

The spring (not shown) presses the driven shaft 49 to press the first driven roller 47a against the first drive roller 41.

The first driven roller 47a is provided so as to be rotatable about the driven shaft 49. The first driven roller 47a sandwiches the recording medium 36 with the first drive roller 41. Similarly, the second driven roller 47b sandwiches the recording medium 36 with the first drive roller 41. The third driven roller 47c and the fourth driven roller 47d sandwich the recording medium 36 with the second drive roller 42. The first driven roller 47a to the fourth driven roller 47d are driven to rotate with respect to the transported recording medium 36.

The first driven unit 43a is provided behind the first drive roller 41 in the depth direction Y. The driven shaft 49 of the first driven unit 43a is provided between the first shaft 51 and the second shaft 52 in the depth direction Y.

The driven shaft 49 of the first driven unit 43a may be aligned with the first shaft 51 of the first drive roller 41 in the depth direction Y. The driven shaft 49 of the first driven unit 43a may be positioned at the same position as the first shaft 51 in the vertical direction Z.

The first driven unit 43a overlaps the second drive roller 42 in the depth direction Y. In other words, the second drive roller 42 overlaps with the first driven unit 43a in the depth direction Y. In the second drive roller 42 of the present embodiment, a front end 42f in the depth direction Y is positioned in front of a rear end 47r of the first driven roller 47a.

The second drive roller 42 overlaps the first driven unit 43a in the vertical direction Z. The first driven unit 43a is positioned between an upper end 42t of the second drive roller 42 and the lower end 42b of the second drive roller 42 in the vertical direction Z.

The second drive roller 42 overlaps the first driven unit 43a as viewed in an axial direction. That is, as shown in FIG. 2, when the second drive roller 42 is viewed in the axial direction, a part of the second drive roller 42 positioned behind the first driven unit 43a is hidden by the first driven unit 43a.

As shown in FIG. 1, the transport roller 44 is rotatable in a forward direction and a reverse direction. The transport roller 44 rotating in the forward direction transports the recording medium 36 in the transport direction Dc from the first curved path 29 toward the discharge path 33. The transport roller 44 rotates forward in accordance with the movement of the image recording section 23. The transport roller 44 intermittently transports the recording medium 36. The transport roller 44 rotates forward at a timing at which the image recording section 23 turns back.

The discharge roller 45 may rotate in a forward direction and a reverse direction in accordance with the driving of the transport roller 44. The discharge roller 45 that rotates forward transports the recording medium 36 toward the discharge tray 16. The discharge roller 45 discharges the recording medium 36 on which recording was performed to the discharge tray 16.

The reversely rotating transport roller 44 and the discharge roller 45 feed the recording medium 36 to the inversion path 31. When recording is performed on both sides of the recording medium 36, the transport roller 44 and the discharge roller 45 feed the recording medium 36 recorded on one side to the inversion path 31.

### Transport Path

The transport path 26 is a path along which the recording medium 36 is transported. In the transport path 26 of the present embodiment, the recording medium 36 fed from the first accommodation section 17, the second accommodation section 19, and the manual feed section 22 is transported.

The first feed path 27, the first curved path 29, the inversion path 31, and the second curved path 32 intersect at an intersection 54. The intersection 54 is a space where ends of a plurality of paths are positioned.

The first feed path 27 is a path between the first feeding section 18 and the intersection 54. The first feed path 27 is a path that feeds the recording medium 36 fed from the first accommodation section 17 to the first curved path 29.

The second feed path 28 is a path between the second feeding section 20 and the intersection 54. The second feed path 28 is a path that feeds the recording medium 36 fed from the second accommodation section 19 to the first curved path 29.

The first curved path 29 is a path that goes straight from downstream ends of the first feed path 27 and the second feed path 28. The first curved path 29 of the present embodiment is positioned above the first feed path 27 and the second feed path 28 in the vertical direction Z. The first curved path 29 is a path between the intersection 54 and the discharge roller 45. The first curved path 29 is a path for feeding the recording medium 36 to the image recording section 23.

The manual feed path 30 is a path between the manual feed section 22 and the first curved path 29. The manual feed path 30 is a path for feeding the recording medium 36 fed by the manual feed section 22 to the first curved path 29.

The discharge path 33 is a path downstream of the discharge roller 45 in the transport direction Dc.

The inversion path 31 is a path between the transport roller 44 and the intersection 54. The inversion path 31 is a path for feeding the recording medium 36 on which recording was performed to the second curved path 32.

The second curved path 32 is a path that goes straight from a downstream end of the inversion path 31. A downstream end of the second curved path 32 merges with the first curved path 29. The second curved path 32 is a path between the intersection 54 and the first curved path 29. The second curved path 32 is a path for feeding the recording medium 36 on which recording was performed to the image recording section 23. The recording medium 36, whose one side has been recorded, is returned to the image recording section 23 via the inversion path 31, the second curved path 32, and the first curved path 29.

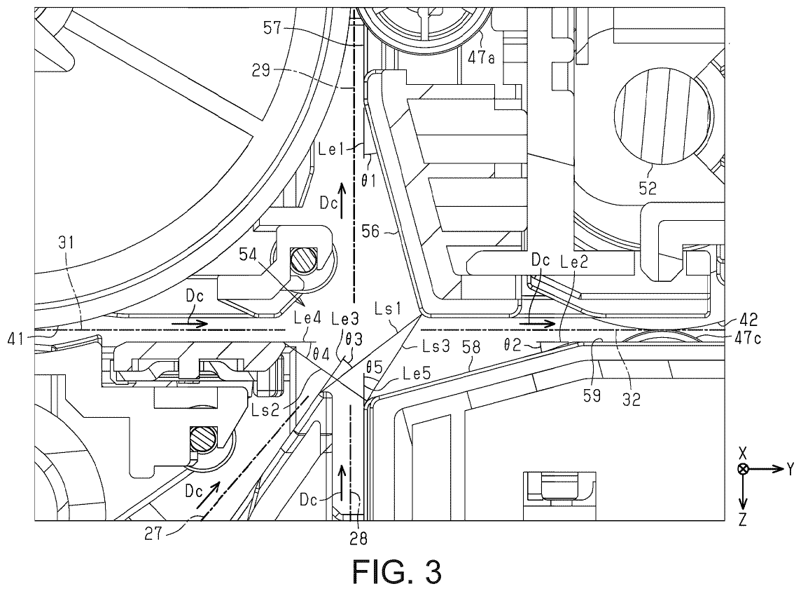

As shown in FIG. 3, the first curved path 29 includes a first guide surface 56 and a first transport surface 57. The second curved path 32 includes a second guide surface 58 and a second transport surface 59.

FIG. 3 shows a first extension line Le1, a second extension line Le2, a third extension line Le3, a fourth extension line Le4, a fifth extension line Le5, a first line segment Ls1, a second line segment Ls2, and a third line segment Ls3, which are imaginary lines.

The first extension line Le1 is an extension line of the first transport surface 57. The first extension line Le1 is a tangent line at an upstream end of the first transport surface 57. The first extension line Le1 is a straight line extending from an upstream end of the first transport surface 57 to an upstream side in the transport direction Dc. The first extension line Le1 may be a vertical line.

The second extension line Le2 is an extension line of the second transport surface 59. The second extension line Le2 is a tangent line at an upstream end of the second transport surface 59. The second extension line Le2 is a straight line extending from an upstream end of the second transport surface 59 to an upstream side in the transport direction Dc. The second extension line Le2 may be a horizontal line.

The third extension line Le3 is an extension line of the first feed path 27. The fourth extension line Le4 is an extension line of the inversion path 31. The fourth extension line Le4 may be a horizontal line. The fifth extension line Le5 is an extension line of the second feed path 28. The fifth extension line Le5 may be a perpendicular line.

The third extension line Le3, the fourth extension line Le4, and the fifth extension line Le5 are straight lines obtained by extending wall surfaces, with which the recording medium 36 come into contact so as to rub, of walls forming the respective paths further to a downstream side from a downstream end in the transport direction Dc.

The first line segment Ls1 is a line connecting a downstream end of the first feed path 27 and an upstream end of the first guide surface 56. The second line segment Ls2 is a line connecting a downstream end of the inversion path 31 and an upstream end of the second guide surface 58. The third line segment Ls3 is a line connecting a downstream end of the second feed path 28 and an upstream end of the first guide surface 56.

The first guide surface 56 guides the recording medium 36 passed from the first feed path 27 and the second feed path 28. The first guide surface 56 and the first transport surface 57 are wall surfaces of walls forming the first curved path 29 with which the recording medium 36 comes into contact in a rubbing manner. The first guide surface 56 is a flat surface. The first guide surface 56 forms a space between itself and the first extension line Le1. The first transport surface 57 is a curved surface along the first drive roller 41. The first guide surface 56 and the first transport surface 57 are outer wall surfaces of the curved first curved path 29. The first guide surface 56 and the first transport surface 57 guide the recording medium 36. The first transport surface 57 extends in the transport direction Dc from a downstream end of the first guide surface 56. The first guide surface 56 forms an acute angle with respect to the first extension line Le1. An angle formed by the first extension line Le1 and the first guide surface 56 is defined as a first angle θ1.

The second guide surface 58 guides the recording medium 36 passed from the inversion path 31. The second guide surface 58 and the second transport surface 59 are wall surfaces of walls forming the second curved path 32 with which the recording medium 36 comes into contact in a rubbing manner. The second guide surface 58 is a flat surface. The second guide surface 58 forms a space between itself and the second extension line Le2. The second guide surface 58 is a wall surface on a lower side in the vertical direction Z. The second transport surface 59 is a curved surface along the second drive roller 42. The second transport surface 59 is an outer wall surface of the curved second curved path 32. The second guide surface 58 and the second transport surface 59 guide the recording medium 36. The second transport surface 59 extends in the transport direction Dc from a downstream end of the second guide surface 58. The second guide surface 58 forms an acute angle with respect to the second extension line Le2. An angle formed by the second extension line Le2 and the second guide surface 58 is defined as a second angle θ2.

An angle formed by the third extension line Le3 and the first line segment Ls1 is defined as a third angle θ3. An angle formed by the fourth extension line Le4 and the second line segment Ls2 is defined as a fourth angle θ4. An angle formed by the fifth extension line Le5 and the third line segment Ls3 is defined as a fifth angle θ5.

Table 1 shows simulation results when the recording medium 36 on which no recording has been performed is fed from the first feed path 27 to the first curved path 29. Table 1 shows the result of transport of the recording medium 36 when the first angle θ1 and the third angle θ3 are changed.

TABLE 1

| | | FIRST ANGLE θ1 | | | | | |
|---|---|---|---|---|---|---|---|
| | | 15° | 20° | 25° | 30° | 35° | 40° |
| THIRD | 10° | POOR | POOR | POOR | POOR | POOR | POOR |
| ANGLE | 15° | POOR | POOR | POOR | POOR | POOR | POOR |
| θ3 | 20° | GOOD | GOOD | GOOD | GOOD | FAIR | POOR |
| | 25° | GOOD | GOOD | GOOD | GOOD | FAIR | POOR |
| | 30° | GOOD | GOOD | GOOD | GOOD | FAIR | POOR |
| | 35° | GOOD | GOOD | GOOD | GOOD | FAIR | POOR |
| | 45° | GOOD | GOOD | GOOD | GOOD | FAIR | POOR |

Table 2 shows simulation results when the recording medium 36 recorded on one side is fed from the inversion path 31 to the second curved path 32. Table 2 shows the result of transport of the recording medium 36 when the second angle θ2 and the fourth angle θ4 are changed.

TABLE 2

| | | SECOND ANGLE θ2 | | | | | |
|---|---|---|---|---|---|---|---|
| | | 15° | 20° | 25° | 30° | 35° | 40° |
| FOURTH | 10° | POOR | POOR | POOR | POOR | POOR | POOR |
| ANGLE | 15° | POOR | POOR | POOR | POOR | POOR | POOR |
| θ4 | 20° | GOOD | GOOD | GOOD | GOOD | FAIR | POOR |
| | 25° | GOOD | GOOD | GOOD | GOOD | FAIR | POOR |
| | 30° | GOOD | GOOD | GOOD | GOOD | FAIR | POOR |
| | 35° | GOOD | GOOD | GOOD | GOOD | FAIR | POOR |
| | 45° | GOOD | GOOD | GOOD | GOOD | FAIR | POOR |

Table 3 shows simulation results when the recording medium 36 on which no recording has been performed is fed from the second feed path 28 to the first curved path 29. Table 3 shows the result of transport of the recording medium 36 when the first angle θ1 and the fifth angle θ5 are changed.

TABLE 3

| | | FIRST ANGLE θ1 | | | | | |
|---|---|---|---|---|---|---|---|
| | | 15° | 20° | 25° | 30° | 35° | 40° |
| FIFTH | 10° | POOR | POOR | POOR | POOR | POOR | POOR |
| ANGLE | 15° | POOR | POOR | POOR | POOR | POOR | POOR |
| θ5 | 20° | GOOD | GOOD | GOOD | GOOD | FAIR | POOR |
| | 25° | GOOD | GOOD | GOOD | GOOD | FAIR | POOR |
| | 30° | GOOD | GOOD | GOOD | GOOD | FAIR | POOR |
| | 35° | GOOD | GOOD | GOOD | GOOD | FAIR | POOR |
| | 45° | GOOD | GOOD | GOOD | GOOD | FAIR | POOR |

As shown in Tables 1 to 3, when the first angle θ1 and the second angle θ2 were 40°, the recording medium 36 was jammed. Specifically, the leading edge of the recording medium 36 stopped against the first guide surface 56 or the second guide surface 58.

When the first angle θ1 and the second angle θ2 were 35°, the recording medium 36 was able to pass over the first guide surface 56 and the second guide surface 58. However, the leading end of the recording medium 36 comes into contact with the first guide surface 56 or the second guide surface 58 and temporarily stops, or the recording medium 36 is curved at the intersection 54, so that the transport of the recording medium 36 becomes unstable.

When the first angle θ1 and the second angle θ2 were 30° or less, the recording medium 36 could be transported smoothly. Therefore, the first angle θ1 is desirably 30° or less. The second angle θ2 is desirably 30° or less.

When the third angle θ3, the fourth angle θ4, and the fifth angle θ5 were 15°, the recording medium 36 was jammed. Specifically, the leading end of the recording medium 36 did not reach the first guide surface 56 or the second guide surface 58.

When the third angle θ3, the fourth angle θ4, and the fifth angle θ5 were 20° or more, the recording medium 36 could be transported. Therefore, the third angle θ3 is desirably 20° or more. The fourth angle θ4 is desirably 20° or more. The fifth angle θ5 is desirably 20° or more.

### Operations of First Embodiment

The operations of the first embodiment will be described.

The recording medium 36 fed from the first accommodation section 17 to the first feed path 27 is delivered to the first curved path 29. The recording medium 36 fed from the second accommodation section 19 to the second feed path 28 is delivered to the first curved path 29. At this time, the leading end of the recording medium 36 is guided by the first guide surface 56.

The recording medium 36 is transported in the transport direction Dc along the first curved path 29. The image recording section 23 performs recording on the recording medium 36 transported to a position facing the head 39. The image recording section 23 performs recording on one side of the recording medium 36.

When recording is performed on one side of the recording medium 36, the control section 14 discharges the recording medium 36 to the discharge tray 16.

When recording is performed on both sides of the recording medium 36, the control section 14 feeds the recording medium 36 to the inversion path 31. The recording medium 36 fed to the inversion path 31 is delivered to the second curved path 32. At this time, the leading end of the recording medium 36 is guided by the second guide surface 58.

After the recording medium 36 merges with the first curved path 29 from the second curved path 32, the recording medium 36 is fed to the image recording section 23. That is, the recording medium 36 recorded on one side is returned to the image recording section 23 through the inversion path 31, the second curved path 32, and the first curved path 29. At this time, a back surface of the recording medium 36, which is opposite to a previously recorded front surface, faces the image recording section 23. The image recording section 23 performs recording on the back surface of the recording medium 36. The control section 14 discharges the recording medium 36 recorded on both sides to the discharge tray 16.

### Effects of First Embodiment

The effects of the first embodiment will be described.

(1-1) The first curved path 29 includes the first guide surface 56 having an acute angle with respect to the first extension line Le1 of the first transport surface 57. The second curved path 32 includes the second guide surface 58 having an acute angle with respect to the second extension line Le2 of the second transport surface 59. By providing the first guide surface 56 and the second guide surface 58, the recording medium 36 can be delivered without using a flap. Therefore, an increase in cost can be suppressed.

(1-2) The first guide surface 56 guides the recording medium 36 fed from the second accommodation section 19. Therefore, the recording medium 36 accommodated in the first accommodation section 17 and the second accommodation section 19 can be passed to the first curved path 29 without using a flap.

(1-3) The third angle θ3 formed by the third extension line Le3 and the first line segment Ls1 is 20° or more. That is, by extending the first guide surface 56 from the position intersecting the third extension line Le3, it is possible to smoothly deliver the recording medium 36.

(1-4) The first angle θ1 formed by the first extension line Le1 and the first guide surface 56 is 30° or less. By reducing the angle of the first guide surface 56 with respect to the first extension line Le1, the recording medium 36 received by the first guide surface 56 can be smoothly transported.

(1-5) The fourth angle θ4 formed by the fourth extension line Le4 and the second line segment Ls2 is 20° or more. That is, by extending the second guide surface 58 from the position intersecting the fourth extension line Le4, it is possible to smoothly deliver the recording medium 36.

(1-6) The second angle θ2 formed by the second extension line Le2 and the second guide surface 58 is 30° or less. By reducing the angle of the second guide surface 58 with respect to the second extension line Le2, the recording medium 36 received by the second guide surface 58 can be smoothly transported.

(1-7) The second drive roller 42 overlaps the first driven unit 43a in the depth direction Y. Therefore, the second drive roller 42 can be provided at a position close to the first drive roller 41. Therefore, an increase in the size of the recording device 11 can be suppressed.

(1-8) The second drive roller 42 overlaps the first driven unit 43a as viewed in an axial direction. Therefore, compared to a case where the second drive roller 42 is provided at a position that does not overlap the first driven unit 43a, it is possible to reduce the region occupied by the transport section 24. Therefore, an increase in the size of the recording device 11 can be suppressed.

### Modifications

The first embodiment can be modified as follows. The first embodiment and the following modifications can be implemented in combination with each other within a range that is not technically contradictory.

The first angle θ1 and the second angle θ2 may be the same angle or different angles. At least one of the first angle θ1 and the second angle θ2 may be larger than 30°. For example, by making the first guide surface 56 and the second guide surface 58 easy to slide, it is possible to reduce the possibility that the recording medium 36 collides.

The recording device 11 may be configured not to include the second accommodation section 19. The recording device 11 may be configured not to include the second feed path 28. In this case, a downstream end of the first feed path 27 and the first guide surface 56 can be provided closer to each other. In a case where the gap between the first feed path 27 and the first curved path 29 is reduced, the third angle θ3 may be smaller than 20°. Similarly, a downstream end of the inversion path 31 and the second guide surface 58 can be provided closer to each other. In a case where the gap between the inversion path 31 and the second curved path 32 is reduced, the fourth angle θ4 may be smaller than 20°.

The second feed path 28 may merge with another path at a position different from the intersection 54. For example, the second feed path 28 may merge with the second curved path 32.

The recording device 11 is not limited to an inkjet type printer, and may be a laser printer, a thermal printer, a dot impact printer, a digital printing machine, or the like.

The recording device may be a liquid ejection device that performs recording by ejecting or discharging liquid other than ink. The state of liquid that is ejected from the liquid ejection device as a minute amount of liquid droplets includes a granular shape, a tear shape, and a shape with a thread-like tail. Here, the liquid may be a material that can be ejected from the liquid ejection device. For example, the liquid may be in a state where a substance is in a liquid phase, and includes a fluid body such as a liquid body having high or low viscosity, a sol, gel water, other inorganic solvents, an organic solvent, a solution, a liquid resin, a liquid metal, and a metal melt. The liquid includes not only liquid as one state of a substance but also liquid in which particles of a functional material made of a solid material such as a pigment or metal particles are dissolved, dispersed, or mixed in a solvent. Typical examples of the liquid include ink and liquid crystal as described in the above-described embodiment. Here, the ink includes various liquid compositions such as general water-based ink, oil-based ink, gel ink, and hot-melt ink. As a specific example of the liquid ejection device, there is a device that ejects liquid containing materials such as electrode materials or color materials used for manufacturing liquid crystal displays, electroluminescence displays, surface-emitting displays, color filters, or the like, in a dispersed or dissolved form. The liquid ejection device may be a device that ejects a bioorganic substance used for manufacturing a biochip, a device that is used as a precision pipette and ejects liquid serving as a sample, a textile printing device, a micro dispenser, or the like. The liquid ejection device may be a device that ejects lubricating oil to precision machinery such as watches or cameras in a pinpoint manner, or a device that ejects a transparent resin liquid such as an ultraviolet curable resin onto a substrate in order to form micro hemispherical lenses, optical lenses, or the like used in optical communication elements or the like. The liquid ejection device may be a device for ejecting an etching liquid such as an acid or an alkali for etching a substrate or the like.

### Definitions

As used herein, the expression “at least one” means “one or more” of the desired options. As an example, the expression “at least one” as used herein means “only one option” or “both of the two options” when the number of options is two. As another example, the expression “at least one” as used herein means “only one option”, “a combination of two optional options”, or “a combination of three or more optional options” when the number of options is three or more.

### Notes

Hereinafter, technical ideas grasped from the above-described first embodiment and modifications, and operations and effects thereof will be described.

(1A) A recording device includes an image recording section that records an image on a recording medium; a first accommodation section configured to accommodate the recording medium; and a transport path on which the recording medium is transported, wherein the transport path includes a first feed path, a first curved path, an inversion path, and a second curved path that intersect at an intersection, the first feed path is a path for feeding the recording medium fed from the first accommodation section to the first curved path, the first curved path is a path for feeding the recording medium to the image recording section, the inversion path is a path for feeding the recording medium on which recording was performed to the second curved path, the second curved path is a path for feeding the recording medium on which recording has been performed to the image recording section, the first curved path includes a first guide surface that guides the recording medium that was passed from the first feed path, and a first transport surface that extends in a transport direction from a downstream end of the first guide surface, the first guide surface forms an acute angle with respect to a first extension line of the first transport surface, the second curved path includes a second guide surface that guides the recording medium passed from the inversion path, and a second transport surface that extends in the transport direction from a downstream end of the second guide surface, and the second guide surface forms an acute angle with respect to a second extension line of the second transport surface.

According to this configuration, the first curved path includes the first guide surface having an acute angle with respect to the first extension line of the first transport surface. The second curved path includes a second guide surface having an acute angle with respect to the second extension line of the second transport surface. By providing the first guide surface and the second guide surface, the recording medium can be delivered without using a flap. Therefore, an increase in cost can be suppressed.

(1B) A recording device may be configured such that the recording device further includes a second accommodation section configured to accommodate the recording medium, wherein the transport path includes a second feed path that intersects the first feed path, the first curved path, the inversion path, and the second curved path at the intersection, the second feed path is a path for feeding the recording medium fed from the second accommodation section to the first curved path, and the first guide surface receives the recording medium passed from the second feed path.

According to this configuration, the first guide surface guides the recording medium fed from the second accommodation section. Therefore, the recording medium accommodated in the first accommodation section and the second accommodation section can be passed to the first curved path without using a flap.

(1C) A recording device may be configured such that an angle formed by a third extension line of the first feed path and a first line segment connecting a downstream end of the first feed path and an upstream end of the first guide surface is 200 or more.

According to this configuration, the angle formed by the third extension line and the first line segment is 20° or more. That is, by extending the first guide surface from a position intersecting with the third extension line, the recording medium can be smoothly delivered.

(1D) A recording device may be configured such that an angle formed by the first extension line and the first guide surface is 30° or less.

According to this configuration, the angle formed by the first extension line and the first guide surface is 30° or less. By reducing the angle of the first guide surface with respect to the first extension line, the recording medium received by the first guide surface can be smoothly transported.

(1E) A recording device may be configured such that an angle formed by a fourth extension line of the inversion path and a second line segment connecting a downstream end of the inversion path and an upstream end of the second guide surface is 20° or more.

According to this configuration, the angle formed by the fourth extension line and the second line segment is 20° or more. That is, by extending the second guide surface from a position intersecting with the fourth extension line, the recording medium can be smoothly delivered.

(1F) A recording device may be configured such that an angle formed by the second extension line and the second guide surface is 30° or less.

According to this configuration, the angle formed by the second extension line and the second guide surface is 30° or less. By reducing the angle of the second guide surface with respect to the second extension line, the recording medium received by the second guide surface can be smoothly transported.

### Second Embodiment

Hereinafter, an embodiment of a recording device will be described with reference to the drawings. The recording device is, for example, an inkjet type printer that prints by ejecting ink, which is an example of liquid, onto a recording medium such as a paper sheet.

In the drawing, assuming that a recording device 111 is placed on a horizontal plane, a direction of gravity is indicated by a Z-axis, and directions along the horizontal plane are indicated by an X-axis and a Y-axis. The X-axis, the Y-axis, and the Z-axis are orthogonal to each other. In the following description, a direction parallel to the X-axis is also referred to as a width direction X, a direction parallel to the Y-axis is also referred to as a depth direction Y, and a direction parallel to the Z-axis is also referred to as a vertical direction Z.

### Recording Device

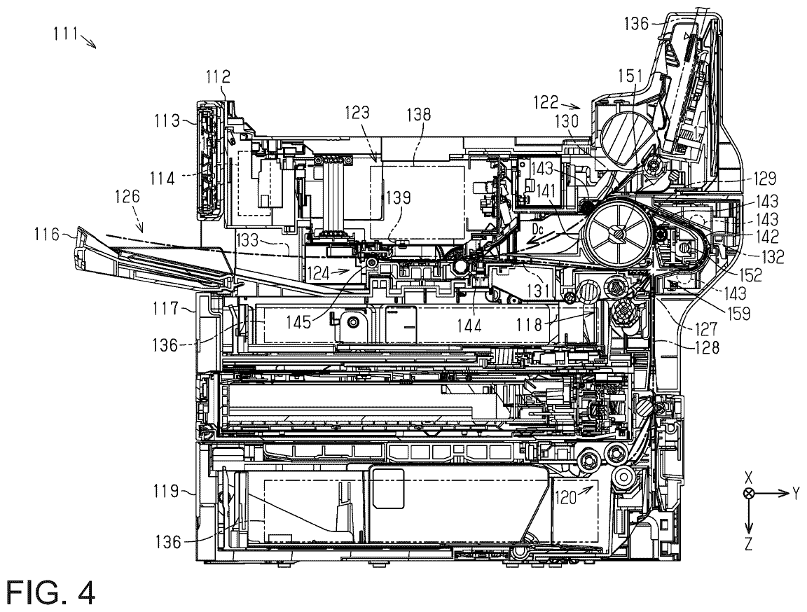

As shown in FIG. 4, the recording device 111 may include a housing 112, an operation section 113, and a control section 114. The recording device 111 may include a discharge tray 116, a first accommodation section 117 as an example of an accommodation section, a first feeding section 118, a second accommodation section 119, and a second feeding section 120. The recording device 111 may include a manual feed section 122, an image recording section 123, and a transport section 124.

The recording device 111 includes a transport path 126. In the drawing, the transport path 126 is indicated by a single dot chain line. The transport path 126 may include a first feed path 127, a second feed path 128, a first curved path 129, a manual feed path 130, an inversion path 131, a second curved path 132, and a discharge path 133, which are examples of feed paths.

The housing 112 accommodates various configurations of the recording device 111.

The operation section 113 is for operating the recording device 111. The operation section 113 of the present embodiment is provided on a front surface of the recording device 111. The operation section 113 is configured to include, for example, a touch-screen, a display, and a button.

The control section 114 integrally controls the driving of each mechanism in the recording device 111. The control section 114 controls various operations executed in the recording device 111.

The control section 114 may be configured as a circuit including α: one or more processors that execute various processes in accordance with a computer program, β: one or more dedicated hardware circuits that execute at least a portion of various processes, or γ: a combination thereof. The hardware circuit is, for example, an application specific integrated circuit. The processor includes a CPU and memory, such as RAM and ROM, and the memory stores program code or commands configured to cause the CPU to perform processes. Memory, that is computer-readable medium, includes any readable medium that can be accessed by a general-purpose or dedicated computer.

The discharge tray 116 receives a recording medium 136 on which recording has been performed. The discharge tray 116 may be provided on a front surface of the recording device 111.

The first accommodation section 117 and the second accommodation section 119 can accommodate the recording medium 136. The first accommodation section 117 and second accommodation section 119 are formed, for example, in a box shape with an open top. The first accommodation section 117 and the second accommodation section 119 can accommodate a plurality of sheets of the recording medium 136 in a stacked state. The first accommodation section 117 and the second accommodation section 119 are individually detachable. The first accommodation section 117 and the second accommodation section 119 are detachable in a state of accommodating the recording medium 136. The first accommodation section 117 and the second accommodation section 119 may be attached by being pushed in the depth direction Y from a front surface of the recording device 111.

The first feeding section 118 feeds a plurality of sheets of the recording medium 136 accommodated in the first accommodation section 117 to the first feed path 127 one by one.

The second feeding section 120 feeds a plurality of sheets of the recording medium 136 accommodated in the second accommodation section 119 to the second feed path 128 one by one.

A plurality of sheets of the recording medium 136 can be set on the manual feed section 122. The recording medium 136 is set on the manual feed section 122 in a state in which a part of the recording medium 36 is exposed to the outside. The manual feed section 122 feeds a plurality of sheets of set recording medium 136 to the manual feed path 130 one by one. The manual feed section 122 may be provided on the first curved path 129 and the second curved path 132.

The image recording section 123 records an image on the recording medium 136. The image recording section 123 may include a carriage 138 and a head 139. The carriage 138 of the present embodiment is configured to reciprocate in the width direction X. The head 139 is mounted on the carriage 138. The head 139 ejects liquid from a plurality of nozzles (not shown). The head 139 performs recording on the recording medium 136 by ejecting liquid toward the recording medium 136 while moving. The recording device 111 of the present embodiment is configured as a serial type printer in which the head 139 moves. The recording device 111 may be configured as a line type printer in which the head 139 is provided to be long in the width direction X.

### Transport Section

The transport section 124 transports the recording medium 136 along the transport path 126. A direction in which the transport section 124 transports the recording medium 136 is referred to as a transport direction Dc. The transport direction Dc is a direction along the transport path 126. The transport section 124 may include a first drive roller 141, second drive rollers 142, driven units 143, a transport roller 144, and a discharge roller 145. The transport section 124 of the present embodiment includes a plurality of driven units 143.

The first drive roller 141 is provided behind the image recording section 123 in the depth direction Y. The first drive roller 141 is provided on a side opposite to the operation section 113 and the discharge tray 116 with respect to the image recording section 123. The first drive roller 141 constitutes a part of the first curved path 129. The first drive roller 141 is rotatable about a first shaft 151, which is an example of a shaft. The first shaft 151 extends in the width direction X. That is, an axial direction of the first drive roller 141 is parallel to the width direction X. The first drive roller 141 rotates to transport the recording medium 136 along the first curved path 129. The first drive roller 141 rotates to transport the recording medium 136 along the inversion path 131.

The second drive roller 142 is provided behind the first drive roller 141 in the depth direction Y.

The second drive roller 142 constitutes a part of the second curved path 132. The second drive roller 142 is rotatable about a second shaft 152, which is an example of a shaft. The second shaft 152 is provided parallel to the first shaft 151. The second shaft 152 extends in the width direction X. An axial direction of the second drive roller 142 is parallel to the width direction X. The second drive roller 142 rotates to transport the recording medium 136 along the second curved path 132.

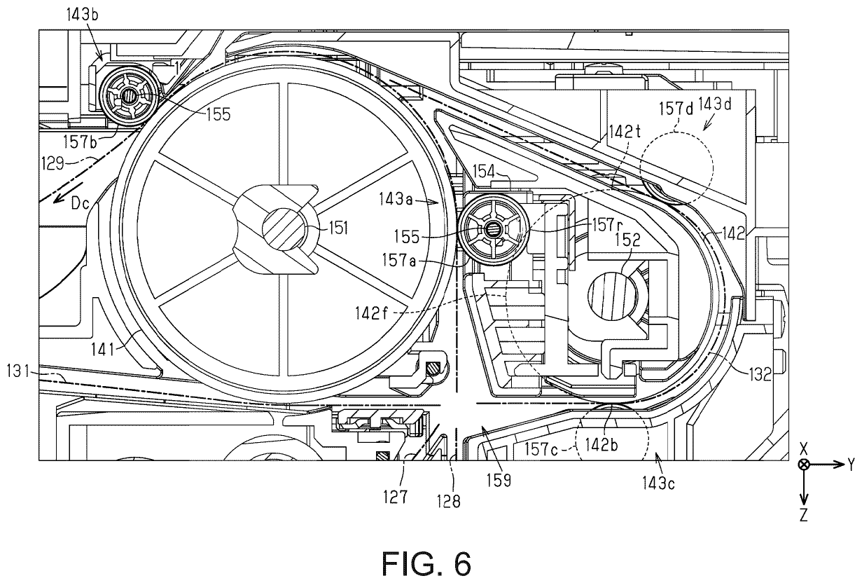

The diameter of the second drive roller 142 may be smaller than the diameter of the first drive roller 141. That is, the curvature of the second curved path 132 is larger than the curvature of the first curved path 129. The second shaft 152 may be positioned below the first shaft 151. In the vertical direction Z, a lower end 142b of the second drive roller 142 shown in FIG. 6 may be positioned at substantially the same position as a lower end of the first drive roller 141. In the vertical direction Z, the first drive roller 141 and the second drive roller 142 may be positioned below the manual feed section 122.

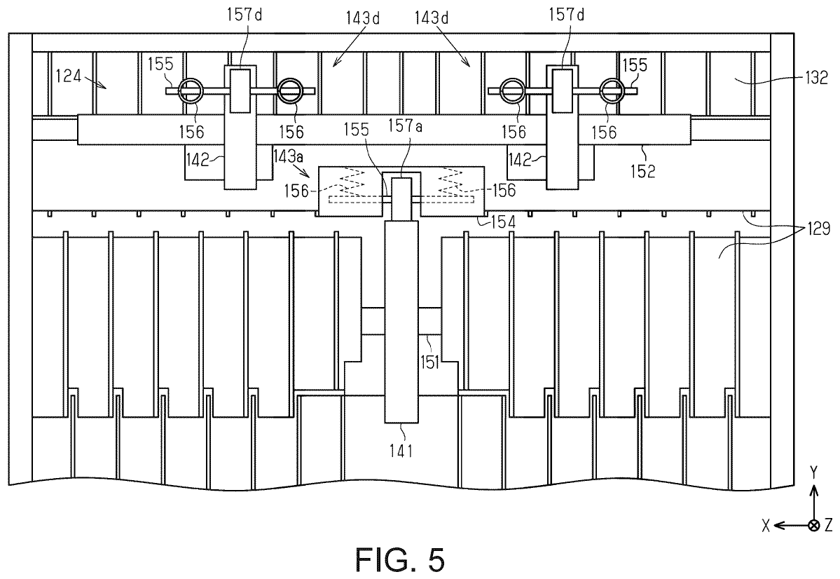

As shown in FIG. 5, the transport section 124 may include a plurality of second drive rollers 142. The plurality of second drive rollers 142 are aligned in an axial direction. The plurality of second drive rollers 142 are rotatable about the same second shaft 152. The plurality of second drive rollers 142 are provided so as to be offset from the first drive roller 141 in the axial direction. In the present embodiment, two second drive rollers 142 are provided on both sides of the first drive roller 141 in the axial direction. When the distances of the two second drive rollers 142 to the first drive roller 141 in the axial direction are set to be the same, the skew of the recording medium 136 to be transported can be reduced.

As shown in FIGS. 5 and 6, a plurality of driven units 143 each have the same configuration. When distinguishing a plurality of driven units 143, also referred to as a first driven unit 143a, a second driven unit 143b, a third driven unit 143c, and a fourth driven unit 143d. The driven unit 143 includes a driven roller. In the present embodiment, the driven rollers respectively included in the first driven unit 143a to the fourth driven unit 143d are also referred to as a first driven roller 157a to a fourth driven roller 157d.

The first driven unit 143a and the second driven unit 143b are provided at the same position as the first drive roller 141 in the width direction X. The first driven unit 143a and the second driven unit 143b sandwich the recording medium 136 with the first drive roller 141.

The transport section 124 may include a plurality of third driven units 143c and a plurality of fourth driven units 143d. The plurality of the third driven units 143c and the plurality of the fourth driven units 143d are provided at the same position as the plurality of second drive rollers 142 in the width direction X, respectively. The third driven unit 143c and the fourth driven unit 143d sandwich the recording medium 136 with the corresponding second drive roller 142.

In the following, the first driven unit 143a will be described, and a common configuration will be denoted by the same reference symbols, so that a duplicate description thereof will be omitted.

As shown in FIG. 5, the first driven unit 143a may include a case 154, a driven shaft 155, a plurality of springs 156, and the first driven roller 157a.

The case 154 accommodates various configurations of the first driven unit 143a. The case 154 holds the driven shaft 155.

The driven shaft 155 extends in the width direction X. An axial direction of the driven shaft 155 is parallel to the first shaft 151 and the second shaft 152. The axial direction of the driven shaft 155 is parallel to the width direction X.

By pressing the driven shaft 155, the plurality of springs 156 press the first driven roller 157a against the first drive roller 141.

The first driven roller 157a is provided so as to be rotatable about the driven shaft 155. The first driven roller 157a sandwiches the recording medium 136 with the first drive roller 141. Similarly, the second driven roller 157b sandwiches the recording medium 136 with the first drive roller 141. The third driven roller 157c and the fourth driven roller 157d sandwich the recording medium 136 with the second drive roller 142. The first driven roller 157a to the fourth driven roller 157d are driven to rotate with respect to the transported recording medium 136.

The first driven unit 143a is provided behind the first drive roller 141 in the depth direction Y. The driven shaft 155 of the first driven unit 143a is provided between the first shaft 151 and the second shaft 152 in the depth direction Y.

The driven shaft 155 of the first driven unit 143a may be aligned with the first shaft 151 of the first drive roller 141 in the depth direction Y. The driven shaft 155 of the first driven unit 143a may be positioned at the same position as the first shaft 151 in the vertical direction Z.

The first driven unit 143a overlaps the second drive roller 142 in the depth direction Y. In other words, the second drive roller 142 overlaps with the first driven unit 143a in the depth direction Y. In the second drive roller 142 of the present embodiment, a front end 142f in the depth direction Y is positioned in front of a rear end 157r of the first driven roller 157a.

The second drive roller 142 overlaps the first driven unit 143a in the vertical direction Z. The first driven unit 143a is positioned between an upper end 142t of the second drive roller 142 and the lower end 142b of the second drive roller 142 in the vertical direction Z.

The second drive roller 142 overlaps the first driven unit 143a as viewed in an axial direction. That is, as shown in FIG. 6, when the second drive roller 142 is viewed in the axial direction, a part of the second drive roller 142 positioned behind the first driven unit 143a is hidden by the first driven unit 143a. When the second drive roller 142 positioned in front of the first driven unit 143a is viewed in an axial direction, the second drive roller 142 hides a part of the first driven unit 143a.

As shown in FIG. 4, the transport roller 144 is rotatable in a forward direction and a reverse direction. The transport roller 144 rotating in the forward direction transports the recording medium 136 in the transport direction Dc from the first curved path 129 toward the discharge path 133. The transport roller 144 rotates forward in accordance with the movement of the image recording section 123. The transport roller 144 intermittently transports the recording medium 136. The transport roller 144 rotates forward at a timing at which the image recording section 123 turns back.

The discharge roller 145 may rotate in a forward direction and a reverse direction in accordance with the driving of the transport roller 144. The discharge roller 145 that rotates forward transports the recording medium 136 toward the discharge tray 116. The discharge roller 145 discharges the recording medium 136 on which recording has been performed to the discharge tray 116.

The reversely rotating transport roller 144 and the discharge roller 145 feed the recording medium 136 to the inversion path 131. When recording is performed on both sides of the recording medium 136, the transport roller 144 and the discharge roller 145 feed the recording medium 136 recorded on one side to the inversion path 131.

### Transport Path

The transport path 126 is a path along which the recording medium 136 is transported. In the transport path 126 of the present embodiment, the recording medium 136 fed from the first accommodation section 117, the second accommodation section 119, and the manual feed section 122 is transported.

The first feed path 127, the first curved path 129, the inversion path 131, and the second curved path 132 intersect at an intersection 159. The intersection 159 is a space where ends of a plurality of paths are positioned.

The first feed path 127 is a path between the first feeding section 118 and the intersection 159. The first feed path 127 is a path that feeds the recording medium 136 fed from the first accommodation section 117 to the first curved path 129.

The second feed path 128 is a path between the second feeding section 120 and the intersection 159. The second feed path 128 is a path that feeds the recording medium 136 fed from the second accommodation section 119 to the first curved path 129.

The first curved path 129 is a path that goes straight from downstream ends of the first feed path 127 and the second feed path 128. The first curved path 129 of the present embodiment is positioned above the first feed path 127 and the second feed path 128 in the vertical direction Z. The first curved path 129 is a path between the intersection 159 and the discharge roller 145. The first curved path 129 is a path for feeding the recording medium 136 to the image recording section 123.

The manual feed path 130 is a path between the manual feed section 122 and the first curved path 129. The manual feed path 130 is a path for feeding the recording medium 136 fed by the manual feed section 122 to the first curved path 129.

The discharge path 133 is a path downstream of the discharge roller 145 in the transport direction Dc.

The inversion path 131 is a path between the transport roller 144 and the intersection 159. The inversion path 131 is a path for feeding the recording medium 136 on which recording has been performed to the second curved path 132.

The second curved path 132 is a path that goes straight from a downstream end of the inversion path 131. A downstream end of the second curved path 132 merges with the first curved path 129. The second curved path 132 is a path between the intersection 159 and the first curved path 129. The second curved path 132 is a path for feeding the recording medium 136 on which recording has been performed to the image recording section 123. The recording medium 136, whose one side has been recorded, is returned to the image recording section 123 via the inversion path 131, the second curved path 132, and the first curved path 129.

### Operations of Second Embodiment

The operations of the second embodiment will be described.

The recording medium 136 fed from the first accommodation section 117 to the first feed path 127 is delivered to the first curved path 129. The recording medium 136 fed from the second accommodation section 119 to the second feed path 128 is delivered to the first curved path 129.

The recording medium 136 is transported in the transport direction Dc along the first curved path 129. The image recording section 123 performs recording on the recording medium 136 transported to a position facing the head 139. The image recording section 123 performs recording on one side of the recording medium 136.

When recording is performed on one side of the recording medium 136, the control section 114 discharges the recording medium 136 to the discharge tray 116.

When recording is performed on both sides of the recording medium 136, the control section 114 feeds the recording medium 136 to the inversion path 131. The recording medium 136 fed to the inversion path 131 is delivered to the second curved path 132.

After the recording medium 136 merges with the first curved path 129 from the second curved path 132, the recording medium 36 is fed to the image recording section 123. That is, the recording medium 136 recorded on one side is returned to the image recording section 123 through the inversion path 131, the second curved path 132, and the first curved path 129. At this time, a back surface of the recording medium 136, which is opposite to a previously recorded front surface, faces the image recording section 123. The image recording section 123 performs recording on the back surface of the recording medium 136. The control section 114 discharges the recording medium 136 recorded on both sides to the discharge tray 116.

### Operations of Second Embodiment

The effects of the second embodiment will be described.

(2-1) The second drive roller 142 overlaps with the first driven unit 143a in the depth direction Y. Therefore, the second drive roller 142 can be provided at a position close to the first drive roller 141. Therefore, an increase in the size of the recording device 111 can be suppressed.

(2-2) The second drive roller 142 overlaps with the first driven unit 143a as viewed in an axial direction. Therefore, compared to a case where the second drive roller 142 is provided at a position that does not overlap the first driven unit 143a, it is possible to reduce the region occupied by the transport section 124. Therefore, an increase in the size of the recording device 111 can be suppressed.

(2-3) The shafts of the first driven roller 157a and the first drive roller 141 are aligned in the depth direction Y. The second drive roller 142 is provided behind the first drive roller 141 in the depth direction Y. When the first drive roller 141, the first driven roller 157a, and the second drive roller 142 are aligned apart from each other in the depth direction Y, the region occupied by the transport section 124 tends to be large. In this regard, by providing the second drive roller 142 so as to overlap the first driven unit 143a, an increase in the size of the recording device 111 can be suppressed.

(2-4) A plurality of second drive rollers 142 are arranged in an axial direction. Therefore, the plurality of second drive rollers 142 can be easily provided so as to avoid the first driven unit 143a.

(2-5) The second shaft 152 of the second drive roller 142 is positioned below the first shaft 151 of the first drive roller 141. Therefore, a space can be easily secured above the second drive roller 142.

(2-6) The diameter of the second drive roller 142 is smaller than the diameter of the first drive roller 141. Therefore, compared to a case where the diameter of the second drive roller 142 is the same as the diameter of the first drive roller 141, it is possible to reduce the region occupied by the transport section 124.

### Modifications

The second embodiment can be implemented with the following modifications. The second embodiment and the following modifications can be implemented in combination with each other as long as there is no technical contradiction.

The second feed path 128 may merge with another path at a position different from the intersection 159. For example, the second feed path 128 may merge with the second curved path 132.

The recording device 111 may be configured not to include the second accommodation section 119. The second accommodation section 119 and the second feeding section 120 may be provided to be attachable to and detachable from the housing 112.

An upper end of the first driven unit 143a may be positioned above the upper end 142t of the second drive roller 142 in the vertical direction Z. An upper end of the first driven roller 157a may be positioned above the upper end 142t of the second drive roller 142.

A lower end of the first driven unit 143a may be positioned below the lower end 142b of the second drive roller 142 in the vertical direction Z. A lower end of the first driven roller 157a may be positioned below the lower end 142b of the second drive roller 142.

The diameter of the second drive roller 142 may be equal to or larger than the diameter of the first drive roller 141.

In the vertical direction Z, the first shaft 151 and the second shaft 152 may be positioned at the same position. In the vertical direction Z, the second shaft 152 may be positioned above the first shaft 151.

The recording device 111 may include only one second drive roller 142.

The recording device 111 may include a plurality of first drive rollers 141 that are rotatable about the first shaft 151. For example, two first drive rollers 141 may be provided on both sides of one second drive roller 142 in an axial direction. The recording device 111 may include a plurality of first driven units 143a. The recording device 111 may include a plurality of second driven units 143b.

The driven shaft 155 of the first driven unit 143a may be positioned below or above the first shaft 151 in the vertical direction Z.

The recording device 111 is not limited to an inkjet type printer, and may be a laser printer, a thermal printer, a dot impact printer, a digital printing machine, or the like.

The recording device may be a liquid ejection device that performs recording by ejecting or discharging liquid other than ink. The state of liquid that is ejected from the liquid ejection device as a minute amount of liquid droplets includes a granular shape, a tear shape, and a shape with a thread-like tail. Here, the liquid may be a material that can be ejected from the liquid ejection device. For example, the liquid may be in a state where a substance is in a liquid phase, and includes a fluid body such as a liquid body having high or low viscosity, a sol, gel water, other inorganic solvents, an organic solvent, a solution, a liquid resin, a liquid metal, and a metal melt. The liquid includes not only liquid as one state of a substance but also liquid in which particles of a functional material made of a solid material such as a pigment or metal particles are dissolved, dispersed, or mixed in a solvent. Typical examples of the liquid include ink and liquid crystal as described in the above-described embodiment. Here, the ink includes various liquid compositions such as general water-based ink, oil-based ink, gel ink, and hot-melt ink. As a specific example of the liquid ejection device, there is a device that ejects liquid containing materials such as electrode materials or color materials used for manufacturing liquid crystal displays, electroluminescence displays, surface-emitting displays, color filters, or the like, in a dispersed or dissolved form. The liquid ejection device may be a device that ejects a bioorganic substance used for manufacturing a biochip, a device that is used as a precision pipette and ejects liquid serving as a sample, a textile printing device, a micro dispenser, or the like. The liquid ejection device may be a device that ejects lubricating oil to precision machinery such as watches or cameras in a pinpoint manner, or a device that ejects a transparent resin liquid such as an ultraviolet curable resin onto a substrate in order to form micro hemispherical lenses, optical lenses, or the like used in optical communication elements or the like. The liquid ejection device may be a device for ejecting an etching liquid such as an acid or an alkali for etching a substrate or the like.

### Definitions

As used herein, the expression “at least one” means “one or more” of the desired options. As an example, the expression “at least one” as used herein means “only one option” or “both of the two options” when the number of options is two. As another example, the expression “at least one” as used herein means “only one option”, “a combination of two optional options”, or “a combination of three or more optional options” when the number of options is three or more.

### Notes

Hereinafter, technical ideas grasped from the above-described second embodiment and modifications, and operations and effects thereof will be described.

(2A) A recording device includes an image recording section that records an image on a recording medium; an accommodation section configured to accommodate the recording medium; a transport path on which the recording medium transported; and a transport section that transports the recording medium, wherein the transport path includes a feed path, a first curved path, an inversion path, and a second curved path that intersect at an intersection, the feed path is a path for feeding the recording medium fed from the accommodation section to the first curved path, the first curved path is a path for feeding the recording medium to the image recording section, the inversion path is a path for feeding the recording medium on which recording was performed to the second curved path, the second curved path is a path for feeding the recording medium on which recording has been performed to the image recording section, the transport section includes a first drive roller, a second drive roller, and a driven unit, the first drive roller is provided behind the image recording section in a depth direction and constitutes the first curved path, the driven unit includes a driven roller that sandwiches the recording medium with the first drive roller, and the second drive roller is provided behind the first drive roller in the depth direction to constitute the second curved path, and overlaps the driven unit in the depth direction.

According to this configuration, the second drive roller overlaps the driven unit in the depth direction. Therefore, the second drive roller can be provided at a position close to the first drive roller. Therefore, an increase in the size of the recording device can be suppressed.

(2B) A recording device includes an image recording section that records an image on a recording medium; an accommodation section configured to accommodate the recording medium; a transport path on which the recording medium is transported; and a transport section that transports the recording medium, wherein the transport path includes a feed path, a first curved path, an inversion path, and a second curved path that intersect at an intersection, the feed path is a path for feeding the recording medium fed from the accommodation section to the first curved path, the first curved path is a path for feeding the recording medium to the image recording section, the inversion path is a path for feeding the recording medium on which recording was performed to the second curved path, the second curved path is a path for feeding the recording medium on which recording has been performed to the image recording section, the transport section includes a first drive roller, a second drive roller, and a driven unit, the first drive roller is provided behind the image recording section in a depth direction and constitutes the first curved path, the driven unit includes a driven roller that sandwiches the recording medium with the first drive roller, and the second drive roller is provided behind the first drive roller in the depth direction to constitute the second curved path, and overlaps the driven unit as viewed in an axial direction.

According to this configuration, the second drive roller overlaps the driven unit as viewed in the axial direction. Therefore, compared to a case where the second drive roller is provided at a position that does not overlap the driven unit, it is possible to reduce the region occupied by the transport section. Therefore, an increase in the size of the recording device can be suppressed.

(2C) A recording device may be configured such that a shaft of the driven roller is aligned with a shaft of the first drive roller in the depth direction.

According to this configuration, the shafts of the driven roller and the first drive roller are aligned in the depth direction. The second drive roller is provided behind the first drive roller in the depth direction. When the first drive roller, the driven roller, and the second drive roller are arranged apart from each other in the depth direction, the region occupied by the transport section tends to be large. In this regard, it is possible to suppress an increase in the size of the recording device by providing the second drive roller so as to overlap the driven unit.

(2D) A recording device may be configured such that the recording device includes a plurality of the second drive rollers aligned in an axial direction.

According to this configuration, the plurality of second drive rollers are provided side by side in the axial direction. Therefore, the plurality of second drive rollers can be easily provided so as to avoid the driven unit.

(2E) A recording device may be configured such that a shaft of the second drive roller is positioned below a shaft of the first drive roller.

According to this configuration, the shaft of the second drive roller is positioned below the shaft of the first drive roller. Therefore, a space can be easily secured above the second drive roller.

(2F) A recording device may be configured such that a diameter of the second drive roller is smaller than a diameter of the first drive roller.

According to this configuration, the diameter of the second drive roller is smaller than the diameter of the first drive roller. Therefore, compared to a case where the diameter of the second drive roller is the same as the diameter of the first drive roller, it is possible to reduce the region occupied by the transport section.

What is claimed is:

1. A recording device comprising:
an image recording section that records an image on a recording medium;
a first accommodation section configured to accommodate the recording medium; and
a transport path on which the recording medium is transported, wherein
the transport path includes a first feed path, a first curved path, an inversion path, and a second curved path that intersect at an intersection,
the first feed path is a path for feeding the recording medium fed from the first accommodation section to the first curved path,
the first curved path is a path for feeding the recording medium to the image recording section,
the inversion path is a path for feeding the recording medium on which recording was performed to the second curved path,
the second curved path is a path for feeding the recording medium on which recording was performed to the image recording section,
the first curved path includes a first guide surface that guides the recording medium that was passed from the first feed path, and a first transport surface that extends in a transport direction from a downstream end of the first guide surface,
the first guide surface forms an acute angle with respect to a first extension line of the first transport surface,
the second curved path includes a second guide surface that guides the recording medium passed from the inversion path, and a second transport surface that extends in the transport direction from a downstream end of the second guide surface, and
the second guide surface forms an acute angle with respect to a second extension line of the second transport surface.

2. The recording device according to claim 1, further comprising:
a second accommodation section configured to accommodate the recording medium, wherein
the transport path includes a second feed path that intersects the first feed path, the first curved path, the inversion path, and the second curved path at the intersection,
the second feed path is a path for feeding the recording medium fed from the second accommodation section to the first curved path, and
the first guide surface guides the recording medium passed from the second feed path.

3. The recording device according to claim 1, wherein
an angle formed by a third extension line of the first feed path and a first line segment connecting a downstream end of the first feed path and an upstream end of the first guide surface is 20° or more.

4. The recording device according to claim 1, wherein
an angle formed by the first extension line and the first guide surface is 30° or less.

5. The recording device according to claim 1, wherein
an angle formed by a fourth extension line of the inversion path and a second line segment connecting a downstream end of the inversion path and an upstream end of the second guide surface is 20° or more.

6. The recording device according to claim 1, wherein
an angle formed by the second extension line and the second guide surface is 30° or less.

7. A recording device comprising:
an image recording section that records an image on a recording medium;
an accommodation section configured to accommodate the recording medium;
a transport path on which the recording medium is transported; and
a transport section that transports the recording medium, wherein
the transport path includes a feed path, a first curved path, an inversion path, and a second curved path that intersect at an intersection,
the feed path is a path for feeding the recording medium fed from the accommodation section to the first curved path, the first curved path is a path for feeding the recording medium to the image recording section,
the inversion path is a path for feeding the recording medium on which recording was performed to the second curved path,
the second curved path is a path for feeding the recording medium on which recording has been performed to the image recording section,
the transport section includes a first drive roller, a second drive roller, and a driven unit,
the first drive roller is provided behind the image recording section in a depth direction and constitutes the first curved path,
the driven unit includes a driven roller that sandwiches the recording medium with the first drive roller, and
the second drive roller is provided behind the first drive roller in the depth direction to constitute the second curved path, and overlaps the driven unit in the depth direction.

8. A recording device comprising:
an image recording section that records an image on a recording medium;
an accommodation section configured to accommodate the recording medium;
a transport path on which the recording medium is transported; and
a transport section that transports the recording medium, wherein
the transport path includes a feed path, a first curved path, an inversion path, and a second curved path that intersect at an intersection,
the feed path is a path for feeding the recording medium fed from the accommodation section to the first curved path,
the first curved path is a path for feeding the recording medium to the image recording section,
the inversion path is a path for feeding the recording medium on which recording was performed to the second curved path,
the second curved path is a path for feeding the recording medium on which recording has been performed to the image recording section,
the transport section includes a first drive roller, a second drive roller, and a driven unit,
the first drive roller is provided behind the image recording section in a depth direction and constitutes the first curved path,
the driven unit includes a driven roller that sandwiches the recording medium with the first drive roller, and
the second drive roller is provided behind the first drive roller in the depth direction to constitute the second curved path, and overlaps the driven unit as viewed in an axial direction.

9. The recording device according to claim 7, wherein
a shaft of the driven roller is aligned with a shaft of the first drive roller in the depth direction.

10. The recording device according to claim 7, wherein
the recording device includes a plurality of the second drive rollers aligned in an axial direction.

11. The recording device according to claim 7, wherein
a shaft of the second drive roller is positioned below a shaft of the first drive roller.

12. The recording device according to claim 11, wherein
a diameter of the second drive roller is smaller than a diameter of the first drive roller.
